(19) United States
(12) Patent Application Publication
(10) Pub. No.: US 2024/0373107 A1
(43) Pub. Date: Nov. 7, 2024

(54) COMMODITY INFORMATION PROCESSING METHOD AND APPARATUS, AND CLIENT

(71) Applicant: Beijing Bytedance Network Technology Co., Ltd., Shijingshan District, Beijing (CN)

(72) Inventor: Mengxiao WANG, Beijing (CN)

(21) Appl. No.: 18/573,273

(22) PCT Filed: Jun. 21, 2022
(86) PCT No.: PCT/CN2022/100190

§ 371 Date: Jul. 10, 2024

(30) Foreign Application Priority Data
Jun. 21, 2021 (CN) 202110686408.9

(51) Int. Cl. H04N 21/81; H04N 21/254; H04N 21/4722

(52) U.S. Cl. CPC H04N 21/816; H04N 21/2542; H04N 21/4722

(57) ABSTRACT

The present disclosure relates to a product information processing method, an apparatus, and a client, and the method is applied to a first client. The method includes: receiving an instruction for generating a video stream for a product; acquiring basic information of the product in response to the instruction; and generating the video stream of the product, and posting the video stream of the product in a second client by a server.

The present application claims the priority to Chinese patent application No. 202110686408.9, filed on Jun. 21, 2021, entitled “product information processing method, apparatus and client,” the entire disclosure of which is incorporated herein by reference as portion of the present application.

### TECHNICAL FIELD

The present disclosure relates to the field of Internet technology and, in particular, to a product information processing method, an apparatus and a client.

### BACKGROUND

At present, a merchant user often adopts the method of creating a video or opening a live broadcast in a client to display information about the product to the buyer user, so as to achieve the purpose of promoting the product. However, the production process of the aforementioned methods is cumbersome, time-consuming, and costly, and requires a lot of time and effort on the part of the merchant user, which brings great inconvenience to the merchant user.

### SUMMARY

In order to solve the above-mentioned technical problems or at least partially solve the above-mentioned technical problems, the present disclosure provides a product information processing method, an apparatus and a client.

In a first aspect, the present disclosure provides a product information processing method, the method is applied to a first client, and the method comprises: receiving an instruction for generating a video stream for a product; acquiring basic information of the product in response to the instruction, in which the basic information of the product comprises a title of the product, a price of the product, and an image of the product; and generating the video stream of the product based on the basic information of the product, and sending the video stream of the product to a server so that the server posts the video stream of the product in a second client.

In one possible design, the video stream of the product comprises images of the product played in rotation in a card style, a dynamically changeable price of the product, and a dynamically changeable title of the product, and the video stream of the product is configured to trigger access to a detail page of the product.

In one possible design, the method further comprises: sending a changed price of the product to the server after a change in the price of the product so that the server updates the price of the product in the video stream of the product posted in the second client based on the changed price of the product.

In one possible design, the method further comprises: sending a changed title of the product to the server after a change in a title of the product so that the server updates the title of the product in the video stream of the product posted in the second client based on the changed title of the product.

In one possible design, the video stream of the product further comprises a detail page tag of the product and/or a store tag of the product, the detail page tag of the product is configured to trigger access to a detail page of the product, and the store tag of the product is configured to trigger access to a homepage of a store to which the product belongs.

In one possible design, acquiring the basic information of the product comprises: acquiring the basic information of the product from a storage module, and basic information of all commodities is stored in the storage module; and/or receiving the basic information of the product uploaded by a user.

In one possible design, the basic information of the product further comprises a content description of the product and/or a piece of background music of the product.

In a second aspect, the present disclosure provides a product information processing apparatus, wherein the apparatus is applied to a first client, and the apparatus comprises: a receiving module, configured to receive an instruction for generating a video stream for a product; an acquisition module, configured to acquire basic information of the product in response to the instruction, in which the basic information of the product comprises a title of the product, a price of the product, and an image of the product; a generation module, configured to generate the video stream of the product based on the basic information of the product; and a sending module, configured to send the video stream of the product to a server so that the server posts the video stream of the product in a second client.

In one possible design, the video stream of the product comprises images of the product played in rotation in a card style, a dynamically changeable price of the product, and a dynamically changeable title of the product, and the video stream of the product is configured to trigger access to a detail page of the product.

In one possible design, the sending module is further configured to: send a changed price of the product to the server after a change in the price of the product so that the server updates the price of the product in the video stream of the product posted in the second client based on the changed price of the product.

In one possible design, the sending module is further configured to: send a changed title of the product to the server after a change in a title of the product so that the server updates the title of the product in the video stream of the product posted in the second client based on the changed title of the product.

In one possible design, the video stream of the product further comprises a detail page tag of the product and/or a store tag of the product, the detail page tag of the product is configured to trigger access to a detail page of the product, and the store tag of the product is configured to trigger access to a homepage of a store to which the product belongs.

In one possible design, the acquisition module is further configured to: acquire the basic information of the product from a storage module, and basic information of all commodities is stored in the storage module; and/or receive the basic information of the product uploaded by a user.

In one possible design, the basic information of the product further comprises a content description of the product and/or a piece of background music of the product.

The beneficial effects of the product information processing apparatus provided in the above-mentioned second aspect and the possible designs of the above-mentioned second aspect can refer to the beneficial effects brought by the above-mentioned first aspect and the possible implementations of the first aspect, and are not repeated here.

In a third aspect, the present disclosure provides a client, which comprises: a processor and a memory; program instructions are stored in the memory; and the processor is used for executing the program instructions in the memory to cause the client to implement the product information processing method of the first aspect and any possible design of the first aspect.

In a fourth aspect, the present disclosure provides a computer storage medium, comprising computer instructions, the computer instructions, when run by an electronic device, cause the electronic device to execute the product information processing method of the first aspect and any possible design of the first aspect.

In a fifth aspect, the present disclosure provides a computer program product, the computer program product, when run by a computer, causes the computer to execute the product information processing method of the first aspect and any possible design of the first aspect.

In a sixth aspect, the present disclosure provides a chip system, which is applied to an electronic device including a display, a memory and a sensor; the chip system includes: a processor; when the processor executes computer instructions stored in the memory, and the electronic device executes the product information processing method of the first aspect and any possible design of the first aspect.

### BRIEF DESCRIPTION OF DRAWINGS

The drawings herein are incorporated into and form a part of the specification, illustrate the embodiments consistent with the present disclosure, and are used in conjunction with the specification to explain the principles of the present disclosure.

In order to more clearly illustrate the technical solutions in the embodiments of the present disclosure or in prior art, the drawings to be used in the description of the embodiments or prior art will be briefly described below, and it will be obvious to those ordinarily skilled in the art that other drawings can be obtained on the basis of these drawings without inventive work.

FIG. 1 is a schematic diagram of a communication system provided by at least one embodiment of the present disclosure;

FIG. 2A-FIG. 2E are schematic diagrams of a human-machine interface provided by at least one embodiment of the present disclosure;

FIG. 3 is a schematic flowchart of a product information processing method provided by at least one embodiment of the present disclosure; and

FIG. 4 is a schematic diagram of a structure of a product information processing apparatus provided by at least one embodiment of the present disclosure.

### DETAILED DESCRIPTION

In order to understand the above objects, features and advantages of the present disclosure more clearly, the solutions of the present disclosure will be further described below. It should be noted that, in case of no conflict, the features in one embodiment or in different embodiments can be combined.

Many specific details are set forth in the following description to fully understand the present disclosure, but the present disclosure can also be implemented in other ways different from those described here; obviously, the embodiments in the specification are a part but not all of the embodiments of the present disclosure.

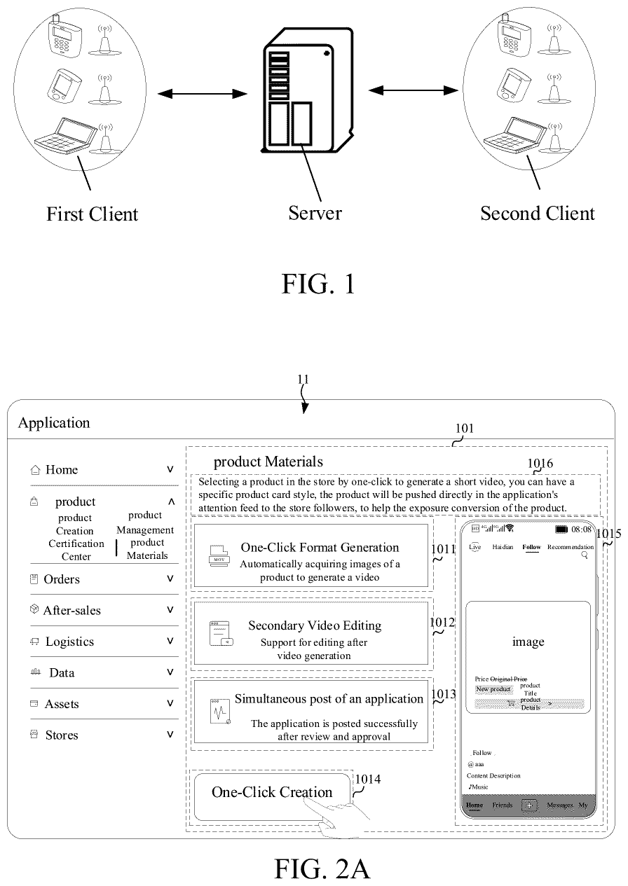

Please refer to FIG. 1, which is a schematic diagram of a communication system provided by at least one embodiment of the present disclosure. As illustrated in FIG. 1, the communication system provided by the present disclosure may include a server and a client, and the server and the client can communicate with each other.

For example, the client may be a client with the function of uploading the basic information of a product (referred to as a background of a product user), a client with the function of displaying the video stream of the product (referred to as a front end of the product user), or a client with the functions of uploading the basic information of the product (merchandise) and displaying the video stream of the product.

For example, the basic information of the product is configured to generally describe the relevant information of the product, and the present disclosure does not limit the specific implementation method of the basic information of the product.

In some embodiments, the basic information of the product may include a title of the product, a price of the product, and an image of the product. The title of the product may include, but is not limited to, descriptive information such as the name, color, type, wearing style, material, and usage feeling of the product. The price of the product is configured to describe the value of the product. The present disclosure does not limit parameters such as format, quantity, and size of the image of the product. The image of the product may include, but is not limited to a front view, a side view, a back view, a detail view, an enlarged view, a usage view, etc. of the product.

In other embodiments, the basic information of the product may also include a content description of the product and/or a piece of background music of the product. For example, the content description of the product can be configured to describe the recommended information of the product, such as recommended usage time or usage collocation, etc. The background music of the product can be played along with the display of other information about the product. The present disclosure does not limit the specific implementation of the background music of the product.

For example, the video stream (feed) of the product is configured to display relevant information of the product in a second client. The present disclosure does not limit the specific implementation of the video stream of the product.

In some embodiments, the video stream of the product includes images of the product played in rotation in a card style, a dynamically changeable price of the product, and a dynamically changeable title of the product.

The rotating images of the product may be understood to mean that all or part of the images of the product may be played sequentially in the video stream of the product using a playback effect such as a slide show. The dynamically changeable price of the product may be understood to mean that the price of the product displayed in the video stream of the product may change as the price of the product acquired by the first client changes. The dynamically changeable title of the product may be understood to mean that the title of the product displayed in the video stream of the product may change as the title of the product acquired by the first client changes.

Moreover, the video stream of the product is further configured to trigger access to a detail page of the product. For example, the detail page of the product is configured to comprehensively describe the relevant information of the product, and the detail page of the product may include, but is not limited to, the basic information of the product, the comment information of the product, the detailed description of the product, and the relevant descriptive information of the store to which the product belongs, etc., and the present disclosure does not limit the specific implementation of the detail page of the product.

In other embodiments, the video stream of the product further includes a detail page tag of the product and/or a store tag of the product, the detail page tag of the product is configured to trigger access to a detail page of the product, and the store tag of the product is configured to trigger access to a homepage of a store to which the product belongs.

For example, the homepage of the store to which the product belongs is configured to describe the relevant information of the store, the homepage of the store to which the product belongs may include, but is not limited to, the basic information of all commodities, the comment information of the store, the reputation information of the store, etc., and the present disclosure does not limit the specific implementation of the homepage of the store to which the product belongs.

For example, the client can realize the product information processing method of the present disclosure by means of an application (APP), a official account, a webpage, etc., in an electronic device, which may include a tablet computer, a laptop computer, an ultra-mobile personal computer (UMPC), a netbook, a personal digital assistant (PDA), a wearable device, an in-vehicle device, a augmented reality (AR)/virtual reality (VR) device, a cellphone (e.g., a folding-screen cellphone, a smartphone, etc.), a smart television, a smart screen, a HDTV, a 4K TV, a smart speaker, a smart projector, and other devices, and the present disclosure does not place any limitations on the specific type of the electronic device.

The present disclosure does not limit the type of operating system of the electronic device, for example, including an Android system, a Linux system, a Windows system or an iOS system, etc.

For ease of illustration, in FIG. 1, a communication system including a first client, a second client, and a server is illustrated by way of example. The first client is a background of the merchant user. The second client is a front end of the merchant user. The server may include, but is not limited to, a server corresponding to a content delivery network (CDN). In addition, the first client and the second client may be the same or different clients.

The first client can receive the basic information of the product uploaded by the merchant user, and save the basic information of the product in a storage module. For example, the basic information of the product includes the title of the product, the price of the product and the image of the product. The storage module may be provided in the first client, in the server, or in both the first client and the server. The present disclosure is not limited in this aspect.

The first client can process the basic information of the product and generate the video stream of the product. Furthermore, the first client can post the video stream of the product to the second client. In this way, the process of generating with one click and posting the video stream of the product based on the basic information of the product can be completed conveniently and quickly, avoiding the phenomenon that the merchant user needs to spend a lot of time and effort, providing the merchant user with a channel to quickly post the product information, simplifying the operation of the merchant user to post the product information, improving the efficiency of the post of the product information, and saving the production cost of the merchant user, so that the merchant user can conveniently and quickly show the buyer user the full range of relevant information about the product, saving the cost of the merchant user to show the product, and helping to increase the purchasing interest of the buyer user.

The first client can communicate with the second client, which may be understood as the first client can synchronize the video stream of the product to the second client through the server. In some embodiments, the first client and the second client can share the same account (such as the same account registered by the merchant user), so that after receiving the video stream of the product sent by the first client, the server can send the video stream of the product to the second client.

In addition, the merchant user can change the price and/or title of the product, so that the first client can receive the changed price and/or title of the product uploaded by the merchant user. After the price and/or title of the product changes, the first client can send the changed price and/or title of the product to the server, and the server can send the changed price and/or title of the product to the second client, so that the second client can display at least the changed price and/or title of the product in the video stream of the product.

In some embodiments, the second client may display the price of the product before and after the change in the video stream of the product. Alternatively, the second client may display a changed title of the product in the video stream of the product.

As a result, the above-mentioned embodiments enable the merchant user to quickly display the changed part of the relevant information of the product to the buyer user, update the relevant information of the product to the user in a timely manner, and meet the needs of the merchant user who needs to change the relevant information of the product.

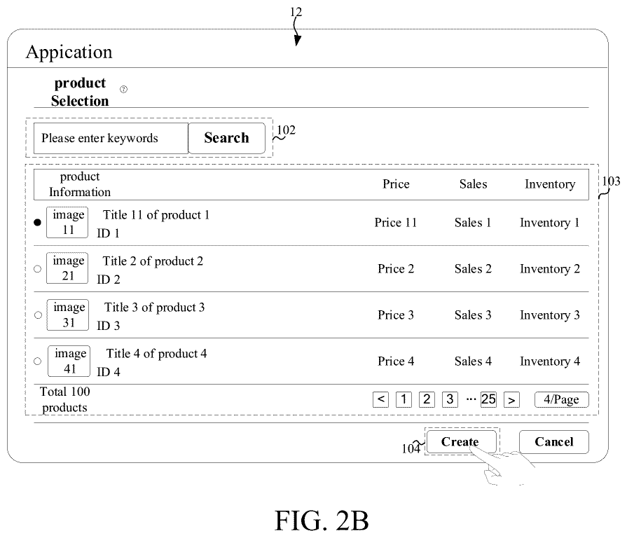

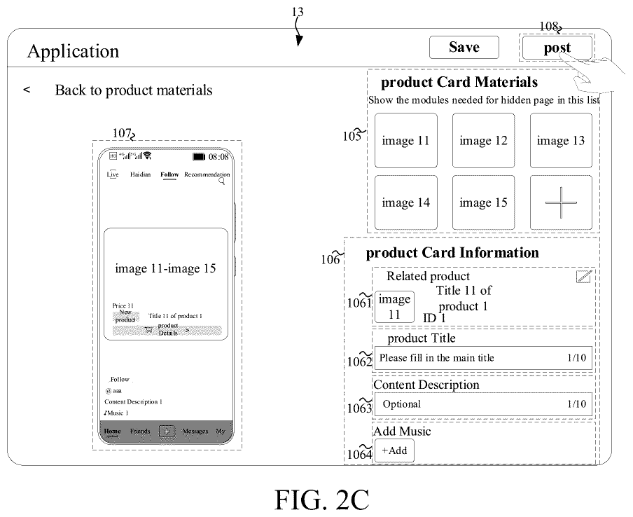

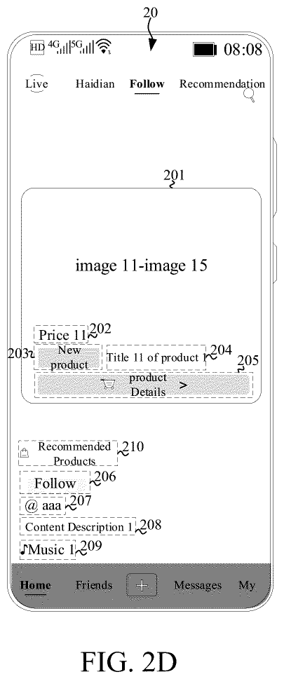

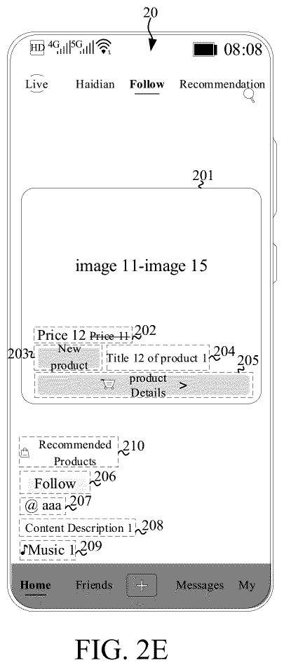

Based on the foregoing description, in conjunction with FIG. 2A-FIG. 2E, the specific implementation process of the product information processing method provided by the present disclosure is described in detail by taking the case where an electronic device installed with a first client is a computer, an electronic device installed with a second client is a cellphone, and a client installed in both the computer and the cellphone is a short-video socialization APP (referred to as Application 1 and Application 2, respectively) as an example.

Please refer to FIG. 2A-FIG. 2E, FIG. 2A-FIG. 2E are schematic diagrams of a human-machine interface provided by at least one embodiment of the present disclosure.

Application 1 can display a user interface 11 illustrated in FIG. 2A on a computer, the user interface 11 is configured to display a management page of a store in the application 1, the management page may provide functional options related to the store such as commodities in the store, orders, after-sales, logistics, data, assets, and a home page of the store, etc., and the present disclosure does not limit the specific implementation of the user interface 11.

In FIG. 2A, the user interface 11 may include a region 101 for describing functional options corresponding to product materials. For example, the region 101 may include a control 1011, a control 1012, a control 1013, a control 1014, a region 1015, and a region 1016.

The control 1011 is configured to provide the function of generating a video stream of a product with one click.

The control 1012 is configured to provide functions of secondary editing for the generated video stream, such as editing duration, editing filters, adding props, etc. It should be noted that the control 1012 is optional.

The control 1013 is configured to provide the function of synchronously posting to a cellphone.

The control 1014 is configured to at least provide the function of generating the video stream of the product with one click and simultaneously posting it to the cellphone, and is further configured to provide the functions of secondary editing for the generated video stream.

The region 1015 is configured to display a preview effect of the video stream of the product posted on the cellphone.

The region 1016 is configured to describe the specific functions of the functional options corresponding to the product materials.

In addition, the user interface 11 may further include other controls and other regions. For example, other controls are configured to enter other functional options of the store, such as the customer service center, etc., and other regions are configured to display other functional options of the store, such as the customer service center, etc.

After the application 1 receives an operation such as clicking the control 1014 performed by the merchant user in the user interface 11 illustrated in FIG. 2A, the application 1 can display a user interface 12 exemplarily illustrated in FIG. 2B on the computer, and the user interface 12 is configured to display a selection page of commodities.

In FIG. 2B, the user interface 12 includes a search box 102, a region 103 and a control 104.

The search box 102 is configured to input keywords such as ID, title, name, etc. of the product, and to search for the product corresponding to the keywords.

The region 103 is configured to display search results and provide the function of selecting a product in the search results. For example, the search results include, but are not limited to, relevant information such as the title, ID, image, selling price, sales volume, and inventory of the product. In addition, commodities in the search results may be displayed in an order such as favorites of the commodities or the time when the commodities were put on the shelves.

The control 104 is configured to generate the video stream of the product based on the basic information of a selected product and enter a preview page. The preview page can display a preview effect of the video stream of the product.

In addition, the user interface 12 may further include other controls and other regions. For example, other controls are configured to cancel the video stream of the product, and other regions are configured to display the function description of the selection page.

After the application 1 receives an operation such as selecting product 1 performed by the merchant user in the region 103 illustrated in FIG. 2B, the application 1 can display a user interface 13 exemplarily illustrated in FIG. 2C on the computer, and the user interface 13 is configured to display the preview page.

In FIG. 2C, the user interface 13 includes a region 105, a region 106, a region 107, and a control 108.

The region 105 is configured to display all images of the product 1 selected for generating the video stream of the product 1, and to provide functions for editing images of the product 1 such as deletion and replacement.

The region 106 is configured to display relevant information of the product 1 such as icon, title, ID, content description, background music and other information prepared for generating the video stream of the product 1. The region 106 may include a region 1061, a region 1062, a region 1063, and a region 1064.

The region 1061 is configured to display the relevant information of the product 1, such as icon, title, ID, etc., selected on the selection page.

The region 1062 is configured to display and fill in the title of the product 1.

The region 1063 is configured to display and fill in the content description of the product 1.

The region 1064 is configured to display and add the background music of the product 1.

The region 107 is configured to display the preview effect of the video stream of the product 1 generated based on the relevant information of the product 1 prepared in the region 106.

The control 108 is configured to generate the video stream of the product 1 based on the relevant information of the product 1 prepared in the region 106.

It should be noted that the region 1062 and the region 1063 are optional to fill in, and the region 1064 is optional to add. In addition, the user interface 13 may further include other controls and other regions. For example, other controls are configured to save the generated video stream of the product 1, and other regions are configured to provide the function of reselecting a product.

After the application 1 receives an operation such as clicking the control 108 performed by the merchant user in the user interface 13 illustrated in FIG. 2C, the application 1 can post the generated video stream of the product 1 to a cellphone by a server. Therefore, the application 1 can display a user interface 20 schematically illustrated in FIG. 2D on the cellphone, and the user interface 20 is configured to display the video stream of the product 1 in the cellphone.

In FIG. 2D, the user interface 20 may include a region 201, a region 202, a label 203, a region 204, a control 205, a label 206, a region 207, a region 208, a region 209, and a region 210.

The region 201 is configured to rotate images of the product 1 in the form of cards (or product cards), and the images of the product 1 herein are images of the product 1 selected in the region 105 illustrated in FIG. 2C.

The region 202 is configured to display the price of the product 1.

The tag 203 is configured to identify the type of the product 1, such as a new product or a recommended product, etc.

The region 204 is configured to display the title of the product 1, and the title of the product 1 here is the title of the product 1 filled in the region 1062 illustrated in FIG. 2C. In the case where the title of the product 1 is not filled in the region 1062 illustrated in FIG. 2C, the title of the product 1 here is part or all of the title of the product 1 displayed in the region 1061 illustrated in FIG. 2C, or, the title of the product 1 here is the text of a default title.

The control 205 is configured to enter a detail page of the product 1.

The tag 206 is configured to identify the account of the store owner of the store to which the product 1 belongs that the user has followed.

The region 207 is configured to display the account of the store owner of the store to which the product 1 belongs.

The region 208 is configured to display the content description of the product 1. The content description of the product 1 here is the content description of the product 1 filled in the region 1063 illustrated in FIG. 2C, or the content description of the product 1 here is the text of a default content description.

The region 209 is configured to display information such as the name of the singer and the name of the music of the background music of the product 1, and the background music of the product 1 here is the background music of the product 1 added in the region 1064 illustrated in FIG. 2C. In the case where the background music of the product 1 is not added in the region 1064 illustrated in FIG. 2C, the information of the background music of the product 1 here is not displayed.

The region 210 is configured to display the store label of the store to which the product 1 belongs. It should be noted that the region 210 is optional.

In summary, the application 1 can generate the video stream of the product 1 with one click based on the basic information of the product 1, and achieve the post of the video stream of the product 1, which reduces the production cost of the merchant user.

When the merchant user changes the price of the product 1 (for example, from a price 11 to a price 12), the application 1 can change from displaying the user interface 20 as exemplarily illustrated in FIG. 2D to displaying a user interface 20 as exemplarily illustrated in FIG. 2E.

In FIG. 2D, the price of the product 1 displayed in the region 202 is the price 11. In FIG. 2E, the price of the product 1 displayed in the region 202 is changed to the price 12 and a crossed-out price 11.

In summary, the application 1 can update the price of the product 1 in the video stream of the product 1 in real time, ensuring the synchronization of the basic information of the product 1 in the video stream of the product 1.

When the merchant user changes the title of the product 1 (for example, from a title 11 to a title 12), the application 1 cans change from displaying the user interface 20 as exemplarily illustrated in FIG. 2D to displaying the user interface 20 as exemplarily illustrated in FIG. 2E.

In FIG. 2D, the title of the product 1 displayed in region 204 is the title 11. In FIG. 2E, the title of the product 1 displayed in region 204 is changed to the title 12.

In summary, the application 1 can update the title of the product 1 in the video stream of the product 1 in real time, ensuring the synchronization of the basic information of the product 1 in the video stream of the product 1.

Based on the description of the foregoing embodiments, the present disclosure will take the first client in FIG. 1 as an example, and elaborate on the product information processing method provided by the present disclosure in conjunction with the drawings and application scenarios.

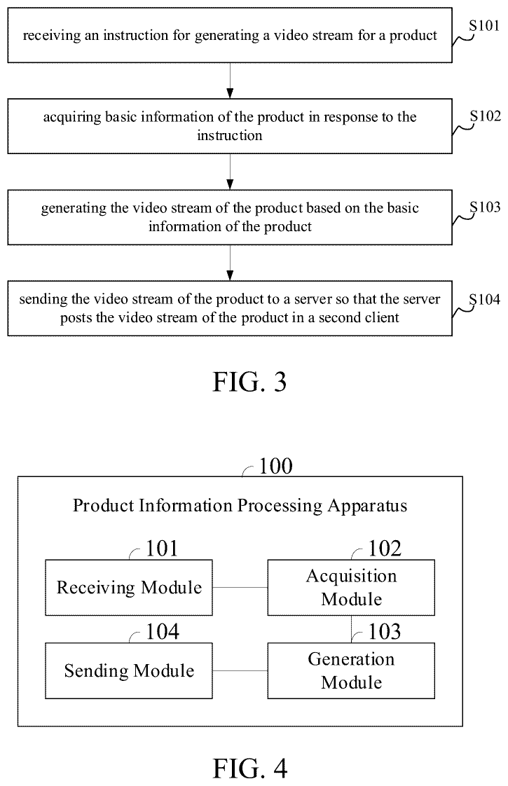

Please refer to FIG. 3, FIG. 3 is a schematic flowchart of a product information processing method provided by at least one embodiment of the present disclosure. As illustrated in FIG. 3, the product information processing method provided by the present disclosure may include the following steps.

S101, receiving an instruction for generating a video stream for a product.

The first client can receive an instruction for generating the video stream for the product sent by the merchant user or provided in advance. For example, the foregoing instruction may be obtained by triggering using a manual operation or an automatic operation, and the manual operation may include, but is not limited to, a type of operation such as clicking, double-clicking, long-pressing, swiping, and the like. In addition, the present disclosure does not limit parameters such as the quantity and type of commodities.

S102, acquiring basic information of the product in response to the instruction.

In a possible implementation, the basic information of the product includes the title of the product, the price of the product, and the image of the product.

S103, generating the video stream of the product based on the basic information of the product.

After receiving the foregoing instruction, the first client can acquire the basic information of the product in order to prepare to provide product materials for the video stream of the product. The present disclosure does not limit the specific implementation for the first client to acquire the basic information of the product.

In some embodiments, because the basic information of all commodities uploaded by the merchant user is pre-stored in a storage module (the storage module mentioned here can be referred to the foregoing description, and will not be described again here), the first client can acquire the basic information of the product from the storage module.

In other embodiments, the first client may receive basic information about the product uploaded by the merchant user in real time.

In other embodiments, the first client may also acquire the basic information of the product by using the foregoing two methods. For example, the first client may use one of the foregoing methods to acquire the title and price of the product, and may use the other of the foregoing methods to acquire an image of the product in order to acquire the basic information about the product.

Therefore, the first client can generate the video stream of the product based on the basic information of the product. The video stream of the product mentioned here can be found in the foregoing description, and will not be described in detail here.

S104, sending the video stream of the product to a server so that the server posts the video stream of the product in a second client.

The first client can post the video stream of the product in the second client by the server, which causes the buyer user to better understand the product through timely viewing of the product, attracts the buyer user to pay attention to the product, provides the merchant user with a channel to quickly post the product information, simplifies the operation of the merchant user to post the product information, and improves the efficiency of the post of the product information.

For example, the first client and the second client may be the same or different. In addition, the second client may recommend the video stream of the product to buyer users who follow the account of the store owner of the store to which the product belongs, or may recommend the video stream of the product to all buyer users. The present disclosure is not limited in this aspect.

In some embodiments, taking the case where the product is the product 1, the first client is a computer, and the second client is a cellphone as an example, the specific implementation process of the foregoing instruction may be referred to the description of clicking on the control 1014 in the user interface 11 illustrated in the embodiment of FIG. 2A; the specific implementation process of the basic information of the product may be referred to the description of selecting the product 1 in the user interface 12 as illustrated in the embodiment of FIG. 2B and editing the basic information of the product 1 in the user interface 13 as illustrated in the embodiment of FIG. 2C; the specific implementation process of the video stream of the product to be posted in the second client may be referred to the description of the user interface 20 as illustrated in the embodiment of FIG. 2D; the specific implementation process of the title of the product may be referred to the description of the region 204 in the user interface 20 illustrated in the embodiment of FIG. 2D; the specific implementation process of the price of the product may be referred to the description of the region 202 in the user interface 20 illustrated in the embodiment of FIG. 2D; the specific implementation process of the image of the product may be referred to the description of the region 201 in the user interface 20 illustrated in the embodiment of FIG. 2D, and will not be repeated here.

The product information processing method provided by the present disclosure can acquire the basic information of the product after receiving the instruction for generating the video stream for the product. The basic information of the product includes the title of the product, the price of the product and the image of the product. The video stream of the product is generated based on the basic information of the product, and the video stream of the product is posted in the second client by the server. As a result, the process of generating with one click and posting the video stream of the product based on the basic information of the product can be completed conveniently and quickly, avoiding the phenomenon that the merchant user needs to spend a lot of time and effort, providing the merchant user with a channel to quickly post the product information, simplifying the operation of the merchant user to post the product information, improving the efficiency of the post of the product information, and saving the production cost of the merchant user, so that the buyer user can quickly learn about the product through the video stream of the product, which enhances the willingness of the buyer user to pay attention to and purchase the product.

Based on the description of the above-mentioned embodiments, the first client can also synchronize the price and/or title of the product in the video stream of the product in real time by the server. As a result, the embodiments of the present disclosure enable the user to be informed of the real-time dynamics of the product in a timely manner, strengthen the real-time sense of displaying the basic information of the product, and contribute to attracting the buyer user to stay more time to browse the content of the video stream of the product.

In order to adapt to the actual needs of the market, the merchant user can modify the price of the product through the first client, so that the first client can receive the changed price of the product, or the first client can receive the changed price of the product uploaded by the merchant user. Therefore, after the first client determines that the price of the product has changed, the first client can send the changed price of the product to the server, so that the server can update the price of the product in the video stream of the product posted in the second client based on the changed price of the product. For example, the second client may display the price of the product before and after the change. In some embodiments, taking the case where the product is the product 1, the first client is a computer, and the second client is a cellphone as an example, the specific implementation process of updating the price of the product may refer to the description of the region 202 in the user interface 20 illustrated in the embodiment that changes from FIG. 2D to FIG. 2E, which will not be repeated herein.

In order to adapt to the actual needs of the market, the merchant user can modify the title of the product through the first client, so that the first client can receive the changed title of the product, or the first client can receive the changed title of the product uploaded by the merchant user. Therefore, after the title of the product has changed, the first client can send the changed title of the product to the server, so that the server can update the title of the product in the video stream of the product posted in the second client based on the changed title of the product. For example, the second client may display the changed title of the product.

In some embodiments, taking the case where the product is the product 1, the first client is a computer, and the second client is a cellphone as an example, the specific implementation process of updating the title of the product may refer to the description of the region 202 in the user interface 20 illustrated in the embodiment that changes from FIG. 2D to FIG. 2E, which will not be repeated herein.

Exemplarily, the present disclosure provides a product information processing apparatus.

Please refer to FIG. 4, FIG. 4 is a schematic diagram of a structure of a product information processing apparatus provided by at least one embodiment of the present disclosure. The product information processing apparatus of the present disclosure can be provided in the first client, and the first client can be installed in an electronic device, so that operations corresponding to the first client in the product information processing method provided in the embodiments of FIG. 1-FIG. 3 mentioned above can be achieved.

As illustrated in FIG. 4, the product information processing apparatus 100 provided by the present disclosure may include a receiving module 101, an acquisition module 102, a generation module 103, and a sending module 104.

The receiving module 101 is to receive an instruction for generating a video stream for a product.

The acquisition module 102 is configured to acquire basic information of the product in response to the instruction.

The generation module 103 is configured to generate the video stream of the product based on the basic information of the product.

The sending module 104 is configured to send the video stream of the product to a server so that the server posts the video stream of the product in a second client.

In some embodiments, the sending module is further configured to send the changed price of the product to the server after the price of the product changes, so that the server can update the price of the product in the video stream of the product posted in the second client based on the changed price of the product.

In some embodiments, the sending module 104 is further configured to send the changed title of the product to the server after the title of the product changes, so that the server can update the title of the product in the video stream of the product posted in the second client based on the changed title of the product.

In some embodiments, the video stream of the product further includes a detail page tag of the product and/or a store tag of the product, the detail page tag of the product is configured to trigger access to a detail page of the product, and the store tag of the product is configured to trigger access to a homepage of a store to which the product belongs.

In some embodiments, the acquisition module 102 is specifically configured to acquire the basic information of the product from a storage module, which stores the basic information of all commodities; and/or receive the basic information of the product uploaded by the user.

In some embodiments, the basic information of the product includes the title of the product, the price of the product, and the image of the product.

In some embodiments, the basic information of the product further includes a content description of the product and/or a piece of background music of the product.

The product information processing apparatus provided by the present disclosure can execute the above-mentioned method embodiments, the specific implementation principles and technical effects of the product information processing apparatus can refer to the above-mentioned method embodiments, and the present disclosure will not be repeated here.

Exemplarily, the present disclosure provides a client, including one or more processors, a memory, and one or more computer programs. The one or more computer programs are stored in the memory, and the one or more computer processor, when executing the one or more computer programs, cause the client to implement the product information processing method according to the foregoing embodiments.

Exemplarily, the present disclosure provides a chip system, and the chip system is applied to an electronic device including a display, a memory, and a sensor. The chip system includes a processor, and when the processor executes computer instructions stored in the memory, the electronic device executes the product information processing method according to the foregoing embodiments.

Exemplarily, the present disclosure provides a computer-readable storage medium on which a computer program is stored, and the computer program is executed by a processor so that an electronic device can implement the product information processing method according to the foregoing embodiments.

Exemplarily, the present disclosure provides a computer program product, and the computer program product, when run by a computer, cause the computer to execute the product information processing method according to the foregoing embodiments.

In the above-mentioned embodiments, all or part of the functions may be implemented by software, hardware, or a combination of software and hardware. When implemented using software, all or part of the implementation may be in the form of a computer program product. The computer program product includes one or more computer instructions. When computer program instructions are loaded and executed on a computer, processes or functions according to the embodiments of the present disclosure are produced, in whole or in part. The computer may be a general-purpose computer, a special-purpose computer, a computer network, or other programmable device. The computer instructions may be stored in a computer-readable storage medium. The computer-readable storage medium may be any available medium that can be accessed by a computer or a data storage device such as a server, data center, etc. that contains one or more available media. The available medium may be a magnetic medium (e.g., a floppy disk, a hard disk, a magnetic tape), an optical medium (e.g., DVD), or a semiconductor medium (e.g., a solid-state disk (SSD)), etc.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The above descriptions are only specific embodiments of the present disclosure, enabling those skilled in the art to understand or implement the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

What is claimed is:

1. A product information processing method, wherein the method is applied to a first client, and the method comprises:
receiving an instruction for generating a video stream for a product;
acquiring basic information of the product in response to the instruction; and
generating the video stream of the product based on the basic information of the product, and sending the video stream of the product to a server so that the server posts the video stream of the product in a second client.

2. The method according to claim 1, wherein the video stream of the product comprises images of the product played in rotation in a card style, a dynamically changeable price of the product, and a dynamically changeable title of the product, and the video stream of the product is configured to trigger access to a detail page of the product.

3. The method according to claim 1, further comprising:
sending a changed price of the product to the server after a change in the price of the product so that the server updates the price of the product in the video stream of the product posted in the second client based on the changed price of the product.

4. The method according to claim 1, further comprising:
sending a changed title of the product to the server after a change in a title of the product so that the server updates the title of the product in the video stream of the product posted in the second client based on the changed title of the product.

5. The method according to claim 1, wherein the video stream of the product further comprises a detail page tag of the product and/or a store tag of the product,
the detail page tag of the product is configured to trigger access to a detail page of the product, and the store tag of the product is configured to trigger access to a homepage of a store to which the product belongs.

6. The method according to claim 1, wherein acquiring the basic information of the product comprises:
acquiring the basic information of the product from a storage module, wherein basic information of all commodities is stored in the storage module; and/or
receiving the basic information of the product uploaded by a user.

7. The method according to claim 1, wherein the basic information of the product comprises a title of the product, a price of the product, and an image of the product.

8. The method according to claim 7, wherein the basic information of the product further comprises a content description of the product and/or a piece of background music of the product.

9. A product information processing apparatus, wherein the apparatus is applied to a first client, and the apparatus comprises:
a receiving module, configured to receive an instruction for generating a video stream for a product;
an acquisition module, configured to acquire basic information of the product in response to the instruction;
a generation module, configured to generate the video stream of the product based on the basic information of the product; and
a sending module, configured to send the video stream of the product to a server so that the server posts the video stream of the product in a second client.

10. A client, comprising:
one or more processors;
a memory; and
one or more computer programs,
wherein the one or more computer programs are stored in the memory; and
the one or more computer processor, when executing the one or more computer programs, cause the client to implement the product information processing method according to claim 1.

11. A computer storage medium, comprising computer instructions, wherein the computer instructions, when run by an electronic device, cause the electronic device to execute the product information processing method according to claim 1.

12. (canceled)

13. The product information processing apparatus according to claim 9, wherein the video stream of the product comprises images of the product played in rotation in a card style, a dynamically changeable price of the product, and a dynamically changeable title of the product, and the video stream of the product is configured to trigger access to a detail page of the product.

14. The product information processing apparatus according to claim 9, wherein the sending module is further configured to: send a changed price of the product to the server after a change in the price of the product so that the server updates the price of the product in the video stream of the product posted in the second client based on the changed price of the product.

15. The product information processing apparatus according to claim 9, wherein the sending module is further configured to: send a changed title of the product to the server after a change in a title of the product so that the server updates the title of the product in the video stream of the product posted in the second client based on the changed title of the product.

16. The product information processing apparatus according to claim 9, wherein the video stream of the product further comprises a detail page tag of the product and/or a store tag of the product,
the detail page tag of the product is configured to trigger access to a detail page of the product, and the store tag of the product is configured to trigger access to a homepage of a store to which the product belongs.

17. The product information processing apparatus according to claim 9, wherein the acquisition module is further configured to:
acquire the basic information of the product from a storage module, wherein basic information of all commodities is stored in the storage module; and/or
receive the basic information of the product uploaded by a user.

18. The product information processing apparatus according to claim 9, wherein the basic information of the product comprises a title of the product, a price of the product, and an image of the product.

19. The product information processing apparatus according to claim 18, wherein the basic information of the product further comprises a content description of the product and/or a piece of background music of the product.

20. The method according to claim 2, further comprising:
sending a changed price of the product to the server after a change in the price of the product so that the server updates the price of the product in the video stream of the product posted in the second client based on the changed price of the product.

21. The method according to claim 20, further comprising:
sending a changed title of the product to the server after a change in a title of the product so that the server updates the title of the product in the video stream of the product posted in the second client based on the changed title of the product.
